(19) United States
(12) Patent Application Publication
(10) Pub. No.: US 2006/0065745 A1
(43) Pub. Date: Mar. 30, 2006

(54) Fabrication method of non-contact IC tag and apparatus of the same and non-contact IC tag

(76) Inventor: Wakahiro Kawai, Kyoto (JP)

Correspondence Address: DICKSTEIN SHAPIRO MORIN & OSHINSKY LLP, 2101 L Street, NW, Washington, DC, 20037, US

(21) Appl. No.: 11/218,577

(22) Filed: Sep. 6, 2005

(30) Foreign Application Priority Data
Sep. 7, 2004 (JP) 2004-259637

(51) Int. Cl. G06K 19/06

(52) U.S. Cl. 235/492

(57) ABSTRACT

A non-contact IC tag which stores information readable by using an induction field from the non-contact IC tag as well as information readable by the other methods, and a fabrication method of the non-contact IC tag are provided. When a non-contact IC tag having a storage unit which stores information and an antenna which communicates in a non-contact manner is fabricated, a magnetic data holding member which magnetically holds data is thermally transferred to a non-contact IC tag main body to provide a magnetic data holding unit.

### BACKGROUND OF THE INVENTION

1. Field of the Invention

The present invention relates to a fabrication method of a non-contact IC tag and an apparatus of the same which fabricate a non-contact IC tag that communicates in a non-contact manner, for example.

2. Description of the Related Art

In order to move automated logistics forward, it is important to make the contents of slips attached to individual articles mechanically readable. As a method of mechanically reading the contents, it is traditionally conducted that a bar code label matching with the contents of each of the individual slips is attached thereto.

However, in order to read a bar code label by using a so-called bar code reader, it is necessary to relate certain distance and directions thereto highly accurately, causing a bottleneck against smooth logistics.

Furthermore, since information content that can be inputted to bar codes is small, a problem arises that the management area of logistics is limited to a small area.

In recent years, a non-contact IC tag has been used that is readable in a non-contact manner with the use of induction fields (see JP-A-9-331279).

Since this non-contact IC tag has smaller constraints in distance and directions in reading than those of bar codes, it is highly convenient. More specifically, it can surely read the contents even from a distance of one meter without receiving constraints on read directivity.

Moreover, since an IC in the non-contact IC tag can store individual information about an article to be a management target in large capacity, the individual information about the article can be used as security information which identifies the individual articles.

On the other hand, the non-contact IC tag like this has a problem that it cannot read the stored data when memory data therein is damaged or its antenna is damaged.

Besides, memory data of anon-contact IC tag is sometimes updated to lose the source of that non-contact IC tag.

### SUMMARY OF THE INVENTION

In view of the problems above, an object of the invention is to provide a non-contact IC tag, a fabrication method of a non-contact IC tag and an apparatus of the same, the non-contact IC tag stores information readable from the non-contact IC tag by using an induction field as well as information readable by the other methods.

The invention is a fabrication method of a non-contact IC tag or an apparatus of the same, the non-contact IC tag having: a storage unit which stores information; and an antenna which communicates in a non-contact manner, wherein a magnetic data holding member which magnetically holds data is thermally transferred to a non-contact IC tag main body.

The storage module includes being configured of memory provided in an IC, and the antenna includes being configured of a loop antenna such as an antenna coil.

The magnetic data holding member includes being formed of a magnetic member having high magnetic holding power or being formed by adding a high permeability member of high permeability to the magnetic member.

With the configuration, in addition to data in the storage unit readable/writable in a non-contact manner, data can be magnetically read and written to the magnetic data holding member thermally transferred. Therefore, a part or all the data can be magnetically recorded as backup of the data stored in the storage unit, and data different from the data in the storage unit can be magnetically recorded.

Thus, convenience in use of the non-contact IC tag can be enhanced, such as identification of types of the non-contact IC tag, use as security information, and traceability to manufacturers.

For an aspect of the invention, a high permeability member of high permeability and a magnetic member magnetically recordable can be used as magnetic data holding members, and the high permeability member and the magnetic member can be separately thermally transferred.

The magnetic member includes being formed by dispersing iron oxide (γFe₂O₃) or chromium dioxide (CrO₂) particles having a crystal grain size of 350 to 380 angstrom in a polyurethane resin binder of thermoplastic resin.

The high permeability member includes being formed by dispersing iron-niobium particles in a resin binder of thermoplastic resin. Furthermore, not limited to iron-niobium alloy particles, it includes using an amorphous sheet of high permeability, or magnetic powder of high permeability such as Ni, Fe, and alloys thereof.

Therefore, the magnetic layer can enhance holding power of magnetic data. Even though the non-contact IC tag is attached with the high permeable layer to an article formed of a member that does not pass magnetic flux such as a metal component and an electronic component, communication can be done in a non-contact manner.

Moreover, the invention can be a non-contact IC tag including: a storage unit which stores information; and an antenna which communicates in a non-contact manner, and further including: a magnetic data holding unit which magnetically holds data.

Thus, in addition to data readable by an induction field, magnetically readable magnetic data can be stored in the non-contact IC tag.

For an aspect the invention, the magnetic data holding unit can be configured of: a high permeable layer which is formed flat of a member of high permeability; and a magnetic layer magnetically recordable.

The magnetic layer includes being formed by dispersing iron oxide (γFe₂O₃) or chromium dioxide (CrO₂) particles having a crystal grain size of 350 to 380 angstrom in a polyurethane resin binder of thermoplastic resin.

The high permeable layer includes being formed by dispersing iron-niobium particles in a resin binder of thermoplastic resin. Furthermore, not limited to iron-niobium alloy particles, it includes using an amorphous sheet of high permeability, or magnetic powder of high permeability such as Ni, Fe, and alloys thereof.

Therefore, the magnetic layer can enhance holding power of magnetic data. Even though the non-contact IC tag is attached with the high permeable layer to an article formed of a member that does not pass magnetic flux such as a metal component and an electronic component, communication can be done in a non-contact manner.

According to the invention, it can provide the non-contact IC tag, the fabrication method of the non-contact IC tag and the apparatus of the same, the non-contact IC tag stores information readable from the non-contact IC tag by using induction fields as well as information readable by the other methods.

### BRIEF DESCRIPTION OF THE DRAWINGS

The teachings of the invention can be readily understood by considering the following detailed description in conjunction with the accompanying drawings, in which:

FIG. 1 is a diagram illustrating the appearance configuration of a non-contact IC tag fabrication apparatus;

FIG. 2 is a cross section illustrating a ribbon;

FIG. 3 is diagrams illustrative of transfer steps;

FIG. 4 is a block diagram illustrating the configuration of the non-contact IC tag fabrication apparatus;

FIG. 5 is a process flowchart illustrating the operation of the non-contact IC tag fabrication apparatus;

FIG. 6 is a plan view illustrating a non-contact IC tag;

FIG. 7 is a front cross section illustrating the non-contact IC tag;

FIG. 8 is a front cross section illustrating the non-contact IC tag attached to an article;

FIG. 9 is a front cross section illustrating the non-contact IC tag attached to an article;

FIG. 10 is a table illustrating the relationship between the number of high permeable layers and communication distance;

FIG. 11 is a perspective view illustrating a notebook personal computer with a non-contact IC tag and an external communication antenna;

FIG. 12 is diagrams illustrative of attachment positions of the non-contact IC tag; and

FIG. 13 is tables illustrating the relationship among the attachment position of the high permeable layer, the number of layers, and communication distance.

### DESCRIPTION OF THE PREFERRED EMBODIMENT

An embodiment according to the invention will be described with reference to the drawings.

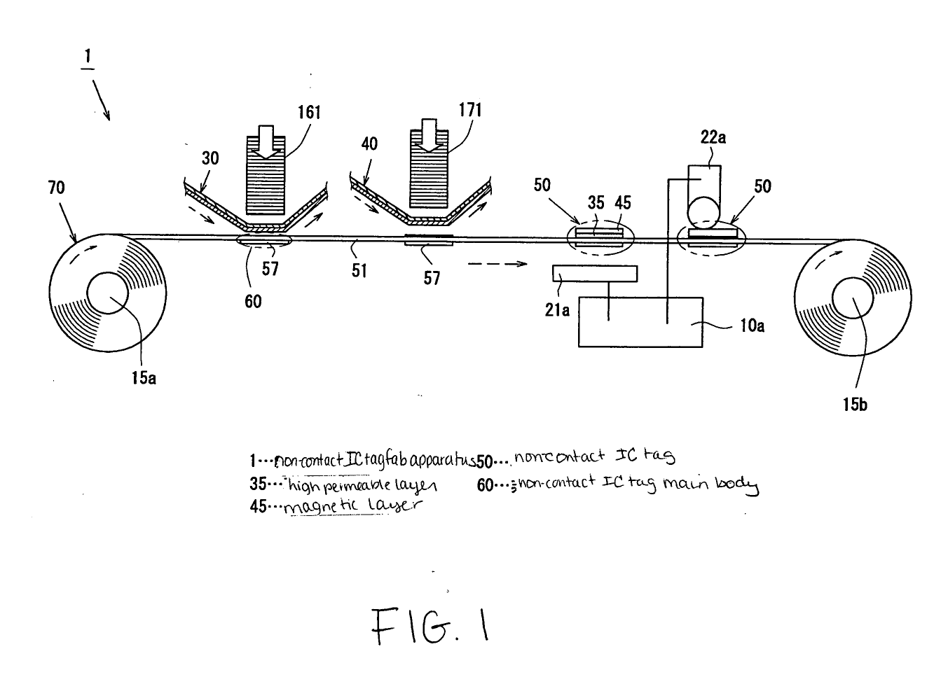

First, with a configuration diagram shown in FIG. 1, the configuration of a non-contact IC tag fabrication apparatus 1 which fabricates a non-contact IC tag having a high permeable layer will be described.

The non-contact IC tag fabrication apparatus 1 has carrier rollers 15a and 15b, a thermal transfer head 161, a thermal transfer head 171, a communication antenna 21a, a magnetic head 22a, and a controller 10a.

In the carrier rollers 15a and 15b, a non-contact IC tag roll 70 is set on the carrier roller 15a, the outer rim end part of the non-contact IC tag roll 70 is set on the carrier roller 15b, and the non-contact IC tag roll 70 is wound from the carrier roller 15a to the carrier roller 15b.

More specifically, with multiple electronic component modules 57 spaced evenly on a sheet 51, the non-contact IC tag roll 70 shaped in a roll is rewound from the carrier roller 15a to the carrier roller 15b.

Thus, the carrier rollers function as carrying modules which carry a non-contact IC tag main body 60 formed of the sheet 51 and the electronic component module 57 from the carrier roller 15a to the carrier roller 15b.

The sheet 51 is wound in a roll shape as the surface having ICs and antenna coils is inside. Therefore, when used in the embodiment, the ICs and the antenna coils are placed on the under surface side of the sheet 51, and a high permeable layer 35 is thermally transferred from the upper side.

In addition, the non-contact IC tag roll 70 is a roll that the electronic component modules 57 configured of the ICs and the antenna coils forming the non-contact IC tag main body 60 are spaced evenly on the sheet 51, in which the sheet 51 is cut out in a shape of the non-contact IC tag main body 60 (for example, a rectangular card shape) to obtain the non-contact IC tag main body 60.

The thermal transfer head 161 is omitted as denoted one head, but multiple heads are disposed in turn along the carrying route of the non-contact IC tag main body 60 by the carrier rollers 15a and 15b.

For each of the thermal transfer heads 161, a single high permeable layer ribbon 30 is set on each head.

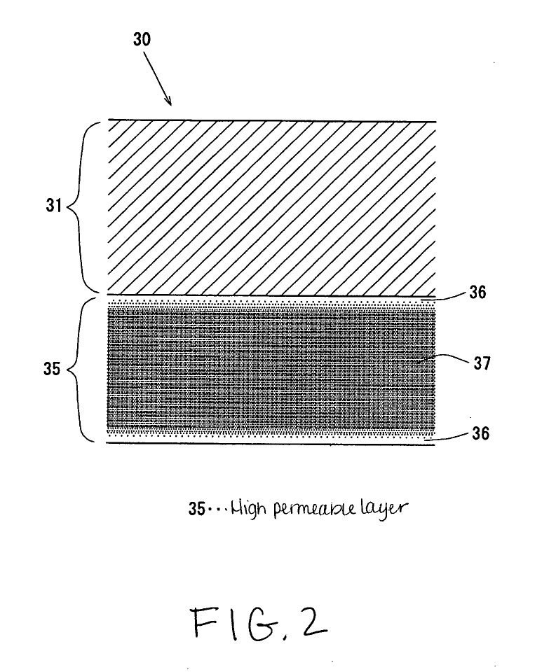

Here, the high permeable layer ribbon 30 is a thermal transfer ribbon which serves as a high permeable layer transfer sheet. As shown in a cross section of FIG. 2, it is formed in a two-layer structure having the high permeable layer 35 on the under surface side of a film 31.

The high permeable layer ribbon 30 uses PET (polyethylene terephthalate) having a thickness of 12 μm as the tape shaped film 31, in which paste is applied onto the surface of the film 31 (the under surface side in the drawing) in a thickness of about 40 to 50 μm to form the high permeable layer 35 (high permeability film) in a film, the paste is formed by dispersing iron-niobium alloy particles ground in a particle diameter of about 5 μm in a polyester resin binder of thermoplastic resin.

Since the paste uses polyester of thermoplastic resin as a binder, it can be applied by a method that it is heated at a temperature of about 150° C. to be softened, continuously applied onto the surface of the film 31 with a bar coater, and cooled and cured at room temperature.

By forming in this manner, as shown in FIG. 2, iron-niobium alloy particles 37 of high permeability particles are dispersed at the center of the high permeable layer 35, and a resin binder 36 of thermoplastic resin is collected on the surface side (both of the upper and lower sides) of the high permeable layer 35.

Therefore, the resin binder 36 dense on the surface can be thermally transferred easily in thermal transfer of the high permeable layer 35 to the non-contact IC tag main body 60 later.

In addition, the high permeable layer ribbon 30 is not limited to this configuration, which may have other configurations in such a way that a proper high permeability member having permeability higher than that of ferrite iron oxide is dispersed in a proper thermoplastic resin.

A single thermal transfer head 171 is disposed at the stage next to the thermal transfer head 161 in the carrying route of the non-contact IC tag main body 60 by the carrier rollers 15a and 15b.

A magnetic layer ribbon 40 is set on the thermal transfer head 171.

Here, the magnetic layer ribbon 40 is a thermal transfer ribbon that serves as a magnetic layer transfer sheet. As similar to the high permeable layer ribbon 30 described above, it is formed in a two-layer structure having a magnetic layer 45 on the under surface side of a film 31.

The magnetic layer ribbon 40 uses PET (polyethylene terephthalate) having a thickness of 12 μm as a tape shaped film 41, in which a magnetic paint is applied onto the surface of the film 31 (the under surface side in the drawing) in a thickness of 0.1 to 0.9 μm to form a magnetic layer 45 (magnetic film) in a film, the magnetic paint is formed that iron oxide (γFe2O3) or chromium dioxide (CrO2) particles having a crystal grain size of 350 to 380 angstrom are dispersed in a polyurethane resin binder of thermoplastic resin.

Since the paint uses polyurethane of thermoplastic resin as a binder, it is applied by a method that it is heated at a temperature of about 150° C. to be softened, continuously applied onto the surface of the film by a bar coater, cooled and cured at room temperature. Furthermore, the magnetic layer 45 is oriented by a magnetic field.

Moreover, the magnetic layer ribbon 40 is not limited to this configuration, which may have other configurations such as a configuration having a sufficient power to hold data by magnetism.

The thermal transfer head 161 shown in FIG. 1 presses the film 31 on the top surface of the high permeable layer ribbon 30 downward at a pressure of about 0.5 Kg/cm² as heated at a temperature of about 130 to 150° C., and thermally transfers the high permeable layer 35 onto the non-contact IC tag main body 60.

At this time, since the resin binder 36 is thermoplastic in which the iron-niobium alloy particles 37 of high permeability particles are dispersed, it is heated and softened by the thermal transfer head 161 and allowed to have adhesion properties.

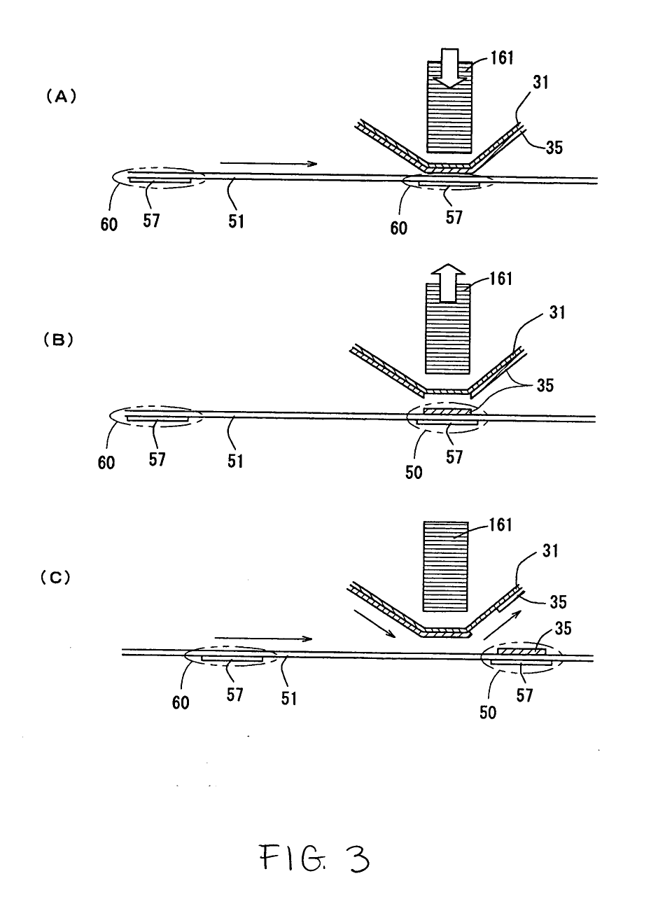

Therefore, the high permeable layer is attached only to the portion contacted to the non-contact IC tag main body 60, and transferred from the high permeable layer ribbon 30. Thus, from the state before transferred shown in the illustration of FIG. 3A to the state after transferred shown in FIG. 3B, the high permeable layer 35 on the high permeable layer ribbon 30 can be partially taken out in a form corresponding to the shape of the thermal transfer head 161, and transferred onto the surface of the non-contact IC tag main body 60 to form the high permeable layer 35 of the non-contact IC tag 50.

In addition, after thermal transfer, as shown in FIG. 3C, the non-contact IC tag 50 configured of the sheet 51, the electronic component module 57 and the high permeable layer 35 is carried by a tag carrying unit 15, and the position of the high permeable layer ribbon 30 is moved by a ribbon carrying unit 17 for setting to allow the next thermal transfer.

Furthermore, as similar to the thermal transfer head 161, the thermal transfer head 171 presses the film 31 on the top surface of the high permeable layer ribbon 40 downward at a pressure of about 0.5 Kg/cm² as heated at a temperature of about 130 to 150° C., and thermally transfers the high permeable layer 45 onto the high permeable layer 35 of the non-contact IC tag main body 60.

At this time, since the resin binder is thermoplastic in which magnetic particles are dispersed, it is heated and softened by the thermal transfer head 171 and allowed to have adhesion properties.

Thus, the magnetic layer is attached only to the portion contacted to the high permeable layer 35 on the non-contact IC tag main body 60, and transferred from the magnetic layer ribbon 40. Therefore, as similar to the high permeable layer ribbon 30 described with FIG. 3, the magnetic layer 45 on the magnetic layer ribbon 40 can be partially taken out in a form corresponding to the shape of the thermal transfer head 171, and transferred onto the surface of the high permeable layer 35 to form the magnetic layer 45 of the non-contact IC tag 50.

The communication antenna 21a shown in FIG. 1 performs data communication with the thin non-contact IC tag 50 to do an IC write process that writes data required for memory in an IC 56 of the non-contact IC tag 50 and an IC readout process that reads written data.

The controller 10a performs a process that allows the magnetic head 22a to write a part or all of data read out of the memory in the IC 56 of the non-contact IC tag 50 by the communication antenna 21a to the magnetic layer 45 of the non-contact IC tag 50.

The magnetic head 22a performs a magnetic write process that magnetically writes data required for the magnetic layer 45 of the non-contact IC tag 50 and a magnetic readout process that magnetically reads written data.

For data written by the magnetic head 22a, the same ID data as ID data written in the memory in the IC 56 is set.

In addition, for data written by the magnetic head 22a, data other than ID data may be set, such as data for tracing IC data written in the memory in the IC 56, data for restoring IC data, or data for identifying the non-contact IC tag 50.

In addition to this, proper data may be set as purposes for use and as requested by customers, such as the number of the high permeable layer 35, resonance frequencies, types of the non-contact IC tag, manufacturer data, sales data, or data for attachment target articles.

With the configuration above, the high permeable layer 35 can be thermally transferred to the non-contact IC tag main body 60 in multi-layer, and the magnetic layer 45 can be thermally transferred onto the high permeable layer 35.

In addition, the non-contact IC tag 50 is designed to have a fixed frequency of a resonance frequency between 5.0 MHz to 12.0 MHz. Thus, even though the non-contact IC tag is attached onto an article that passes no magnetic flux, a magnetic flux is passed into the antenna coil of the non-contact IC tag through the high permeable layer formed flat to allow secure communication.

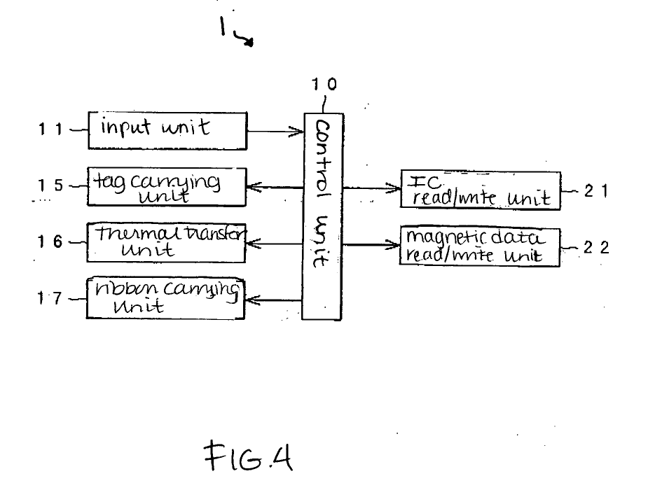

Next, the configuration of the non-contact IC tag fabrication apparatus 1 will be described with reference to a block diagram shown in FIG. 4.

The non-contact IC tag fabrication apparatus 1 is connected to a control unit 10, having an input unit 11, the tag carrying unit 15, a thermal transfer unit 16, the ribbon carrying unit 17, an IC data read/write unit 21, and a magnetic data read/write unit 22.

The control unit 10 is configured of a CPU, which performs various control processes. Furthermore, it has the controller 10a (FIG. 1), and it performs a process by the controller 10a that allows the magnetic head 22a to write ID data read out of the memory in the IC 56 of the non-contact IC tag 50 by the communication antenna 21a to the magnetic layer 45.

The input unit 11 is operation switches that transmit inputted signals to the control unit 10, which accepts input of instructions such as the start or stop of fabrication of the non-contact IC tag 50, and setting the number of layers of the high permeable layer 35.

In addition, the input unit 11 is not limited to operation switches. It may be configured that it is connected to a PC (personal computer), for example, and accepts input for various adjustments such as the number of layers, data written by the IC data read/write unit 21, data written by the magnetic data read/write unit 22, the temperature and pressure of the thermal transfer unit 16, and fabrication rate by a mouse and a keyboard on the PC screen.

The tag carrying unit 15 has the carrier rollers 15a and 15b (FIG. 1) described above, which rotates the carrier rollers 15a and 15b to move the non-contact IC tag main body 60.

The thermal transfer unit 16 has the thermal transfer heads 161 and 171 (FIG. 1) described above, which heats the thermal transfer heads 161 and 171 and applies pressure thereto by downward motion in accordance with the control signal of the control unit 10.

At this time, the rollers sandwich the sheet 51 to thermally transfer the high permeable layer 35 onto the surface opposite to the surface having ICs and antenna coils, and to thermally transfer the magnetic layer 45 onto the high permeable layer 35. Thus, the influence of varying tag properties such as resonance frequencies caused by irregular antenna coils is prevented or reduced.

The ribbon carrying unit 17 stops winding forward (feeding) the high permeable layer ribbon 30 or/and the magnetic layer ribbon 40 during thermal transfer by the thermal transfer unit 16 whereas winds forward during no thermal transfer in accordance with the control of the control unit 10, and it carries the high permeable layer ribbon 30 or/and the magnetic layer ribbon 40 to the next thermal transfer position to come to an end.

The IC data read/write unit 21 has the communication antenna 21a, which performs data communication with the non-contact IC tag 50 in accordance with the control signal of the control unit 10 to do processes that read and write data required for the non-contact IC tag 50.

The magnetic data read/write unit 22 has the magnetic head 22a to perform processes that read and write required data to the magnetic layer 45 of the non-contact IC tag 50 by magnetism in accordance with the control signal of the control unit 10.

With the configuration above, the high permeable layer 35 and the magnetic layer 45 can be thermally transferred to the non-contact IC tag main body 60, and magnetic data can be written to the magnetic layer 45.

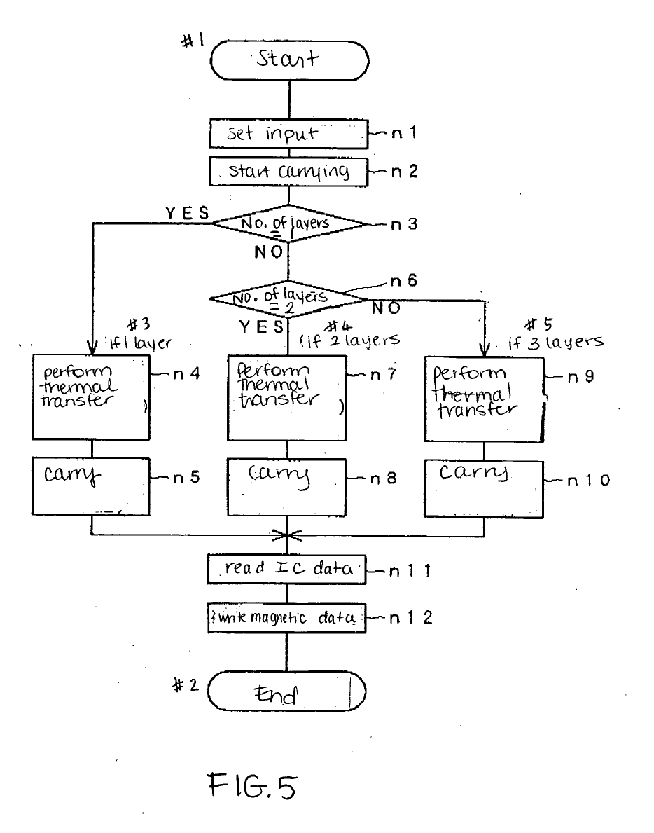

Next, the operation of the overall non-contact IC tag fabrication apparatus 1 will be described with reference to a process flow chart shown in FIG. 5.

In the embodiment, the case of providing three thermal transfer heads 161 will be described.

The control unit 10 first accepts input by a user with the input unit 11, such as setting the number of layers of the high permeable layer 35, setting letters or graphics to be written by the IC data read/write unit 21, and setting data to be recorded by the magnetic data read/write unit 22 (Step n1).

The control unit 10 allows the tag carrying unit 15 to rotate the non-contact IC tag roll 70 and to carry the non-contact IC tag main body 60 attached thereto (Step n2).

When the number of layers set is one or below (Step n3: Yes), the thermal transfer head 161 and the thermal transfer head 171 at the first stage thermally transfer the high permeable layer 35 and the magnetic layer 45 to the non-contact IC tag main body 60 (Step n4). At this time, the thermal transfer head 161 in the upstream thermally transfers the high permeable layer 35, and the thermal transfer head 171 in the downstream thermally transfers the magnetic layer 45 to laminate the magnetic layer 45 on the surface of the high permeable layer 35.

After thermal transfer is done, the high permeable layer ribbon 30, the magnetic layer ribbon 40, and the non-contact IC tag roll 70 are carried (moved) to the next thermal transfer position for the next thermal transfer (Step n5).

When the number of layers set at the Step n3 is not one or below (Step n3: No), it is determined whether the number of layers is two or below (Step n6).

When the number of layers is two or below (Step n6: Yes), the thermal transfer head 161 and the thermal transfer head 171 at the first to second stages thermally transfer the high permeable layer 35 and the magnetic layer 45 to the non-contact IC tag main body 60 to form the high permeable layer 35 in two layers (Step n7).

After thermal transfer is done, the high permeable layer ribbon 30, the magnetic layer ribbon 40, and the non-contact IC tag roll 70 at the first to second stages are carried to the next thermal transfer position for the next thermal transfer (Step n8).

When the number of layers are not two or below at the Step n6 (Step n6: No), the thermal transfer head 161 and the thermal transfer head 171 at the first to third stages thermally transfer the high permeable layer 35 and the magnetic layer 45 to the non-contact IC tag main body 60 to form the high permeable layer 35 in three layers (Step n9).

After thermal transfer is done, the high permeable layer ribbon 30, the magnetic layer ribbon 40, and the non-contact IC tag roll 70 at the first to third stages are carried to the next thermal transfer position for the next thermal transfer (Step n10).

In this manner, thermal transfer and carrying are repeated in turn to laminate and form the high permeable layer 35 and the magnetic layer 45 on the non-contact IC tag main body 60. Furthermore, for the high permeable layer 35, it is laminated from above to repeat thermal transfer to form multiple layers.

The control unit 10 reads ID data out of the memory in the IC 56 of the non-contact IC tag 50 (Step n11), and writes the ID data to the magnetic layer 45 (Step n12).

By the operation above, the high permeable layer 35 is thermally transferred and laminated only by the number of layers inputted by the input unit 11 to further laminate the magnetic layer 45, and then the non-contact IC tag 50 can be fabricated in which ID data stored in the memory in the IC 56 of the non-contact IC tag 50 is also recorded in the magnetic layer 45.

Therefore, ID data recorded in the magnetic layer 45 of the non-contact IC tag 50 is the same ID data as that recorded in the IC 56, and is used as backup. Thus, even though the IC 56 is damaged during the use of the non-contact IC tag 50, the ID data recorded in the magnetic layer 45 can be read by the magnetic head to trace data recorded in the IC 56 and to compensate data.

Since the data recorded in the magnetic layer 45 cannot be read by eyes from outside, the ID data of the IC 56 of the non-contact IC tag 50 cannot be known easily to secure security.

Furthermore, since the magnetic layer 45 and the high permeable layer 35 are laminated with each other and are thermally welded by the ingredients of the resin binders thereof, ID data as magnetic data is integrally recorded in the magnetic layer 45 and the high permeable layer 35, and data can be held for a long time by magnetic holding power of the magnetic layer 45.

Moreover, the magnetic layer 45 is laminated with the high permeable layer 35 to allow the magnetic flux passing through the inside of an antenna coil 53 of the non-contact IC tag 50 to pass through the high permeable layer 35 and to be guided to the outside of the antenna coil 53. In addition to this, it also passes through the magnetic layer 45 and is guided to the outside of the antenna coil 53. Thus, the magnetic layer 45 can reinforce the function of the high permeable layer 35 to pass the magnetic flux.

Besides, the thermal transfer head 161 in turn thermally transfers the high permeable layer 35 to allow enhanced communication distance properties at low cost.

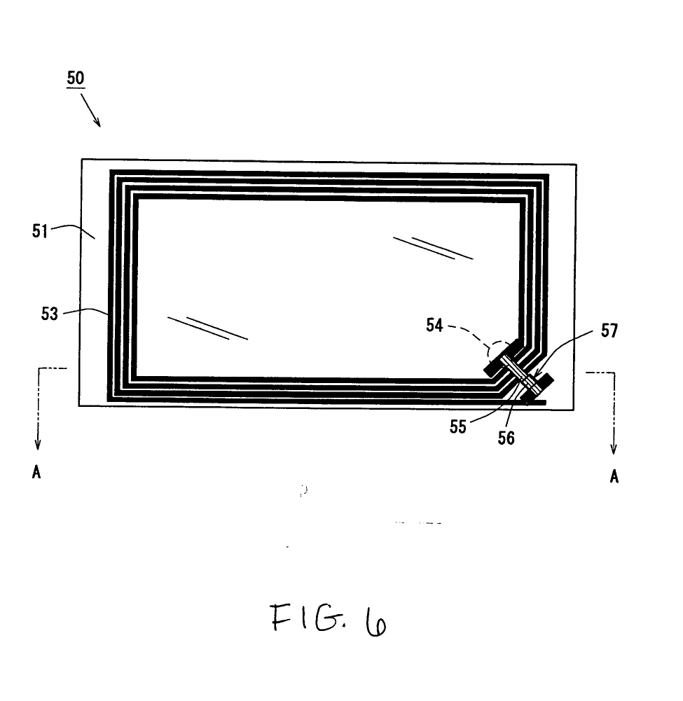

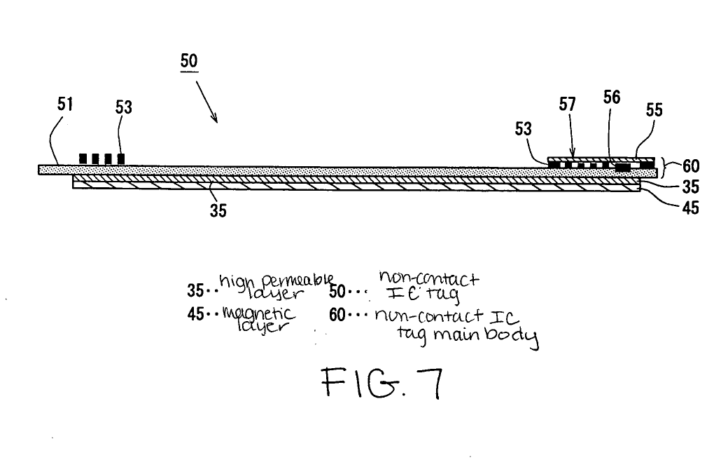

The non-contact IC tag 50 thus completed has the high permeable layer 35 on one surface of the non-contact IC tag main body 60 as shown in a plan view of FIG. 6 and an A-A cross section of FIG. 7, and it is configured to further have the magnetic layer 45 on that surface.

Here, the non-contact IC tag main body 60 is formed in which a module board 55 mounted with the IC 56 is mechanically joined to the antenna coil (winding coil) 53 formed on the sheet 51 at a joining point 54.

The antenna coil 53 is formed of a spiral conductor pattern formed by etching Cu having a thickness of 9 μm.

The sheet 51 is formed of a PET film (polyethylene terephthalate) having a thickness of 38 μm.

The module board 55 is a resin base material, and formed of a PET film base material having a thickness of 25 μm.

The electronic component module 57 is formed with the IC (bare chip IC) 56 mounted on the module board 55. The IC 56 is mechanically joined to the both ends of the antenna coil 53.

The high permeable layer 35 is disposed on one surface of the sheet 51 having no electronic component module 57.

The magnetic layer 45 is disposed on one surface of the sheet 51 having no electronic component module 57, as similar to the high permeable layer 35. It is laminated on the high permeable layer 35 to be formed in the same size as that of the high permeable layer 35.

The non-contact IC tag 50 thus fabricated can write and read data to the magnetic layer 45 by the magnetic head 22a from the surface having the magnetic layer 45.

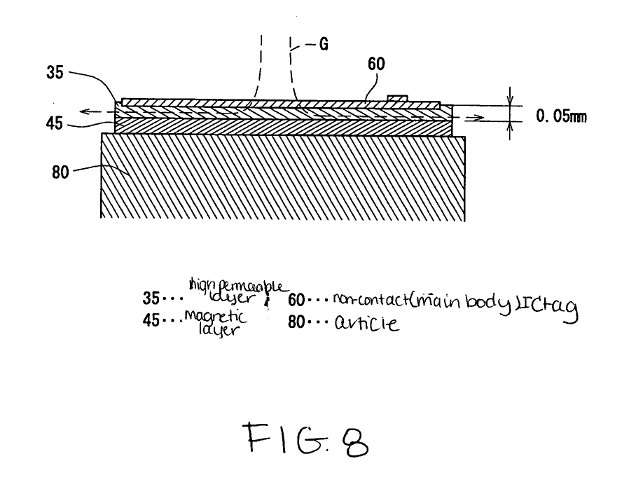

Furthermore, as shown in a front cross section of FIG. 8, even though an article 80 attached with the non-contact IC tag 50 is an aluminium plate material that passes no or scarce magnetic flux, magnetic flux G penetrates through the center of the antenna coil 53 (not shown) to pass through the high permeable layer 35. Therefore, it can normally do data communication.

More specifically, the magnetic flux can be prevented from penetrating through the inside of the antenna coil of the non-contact IC tag because the properties of the non-contact IC tag, such as resonance frequencies and the Q value, are varied by metals and an induction field is blocked by metals.

Moreover, at this time, the magnetic flux G also penetrates through the magnetic layer 45, not shown. Since the non-contact IC tag main body 60 is separated from the article 80 also by the thickness of the magnetic layer 45, the magnetic layer 45 reinforces the function of the high permeable layer 35 to pass the magnetic flux.

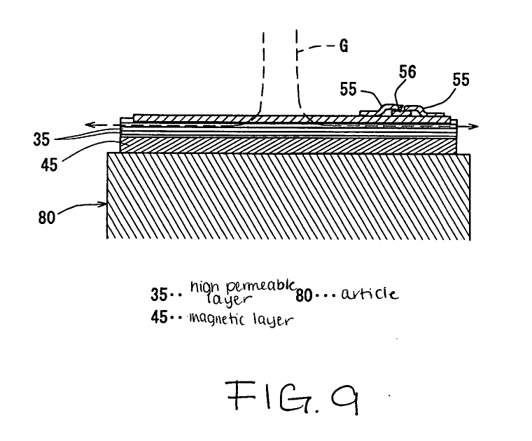

Besides, when the high permeable layer 35 is laminated in multiple layers to form the multi-layer structure, the overall high permeable layer 35 further passes the magnetic flux, as shown in a front cross section of FIG. 9. Thus, even when the article 80 does not pass the magnetic flux and one layer of the high permeable layer 35 does not allow communication, multiple layers of the high permeable layers 35 allow communication.

In this manner, the number of layers to laminate the thin-film high permeable layer 35 having a thickness of 40 to 50 μm is freely adjusted to control thickness, and thus the size of the area of the cross section through which the magnetic flux passes can be adjusted.

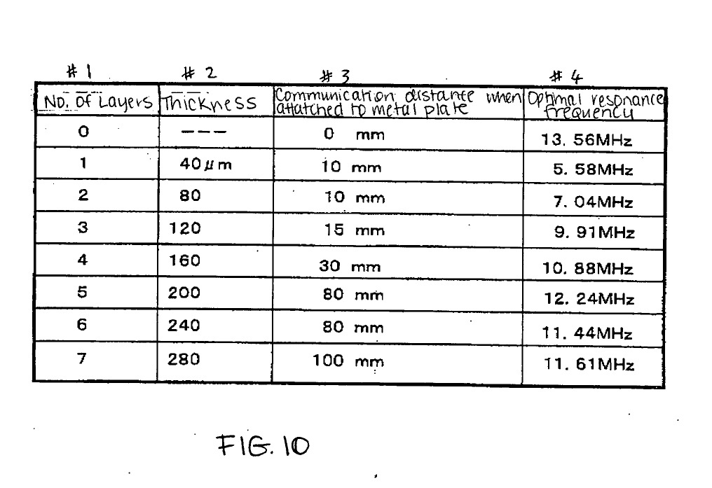

Therefore, as shown in a table of FIG. 10, the adjustment can be done so that the communication distance of an article of a metal plate (for example, an aluminium plate material) that passes no magnetic flux with the non-contact IC tag 50 attached is prolonged by thickening the high permeable layer 35.

Sine the high permeable layer 35 is expensive, the needed thickness is adjusted in accordance with the required communication distance and the properties of an article, and the non-contact IC tag 50 matched with the user's purposes for use can be offered at low cost.

Furthermore, fabrication process steps are unnecessary that a sheet-shaped high permeability member is cut in order to match with the shape of the non-contact IC tag main body 60 and an adhesive is applied onto the cut high permeability member or the non-contact IC tag main body 60 to attach them. Thus, mass production is enhanced to realize low-cost fabrication.

Moreover, the high permeable layer ribbon 30 and the magnetic layer ribbon 40 can be produced in mass volume by a simple process step that the high permeability member or the magnetic member is applied onto a tape shaped film. Therefore, material costs can be more reduced than the case of using an amorphous sheet and a plate material.

Besides, since no special treatment is needed for the article 80 of an attachment target, any articles can be attached easily for use.

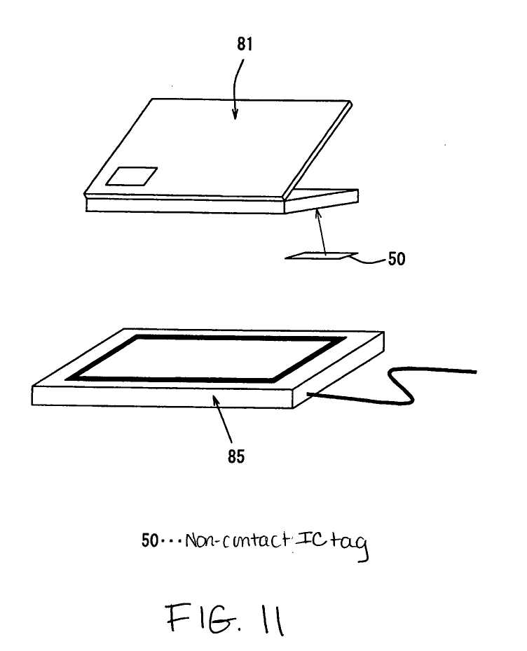

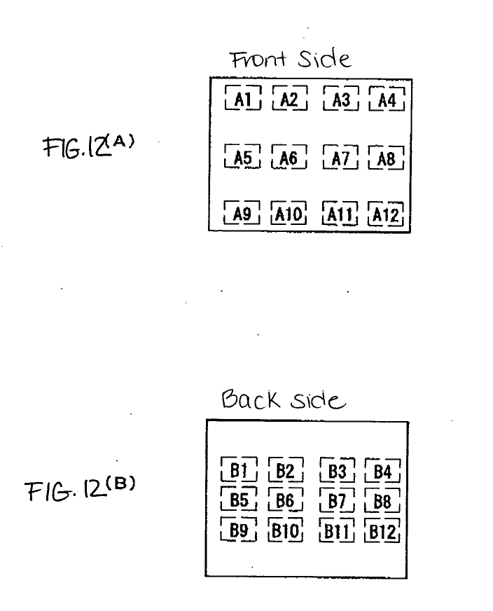

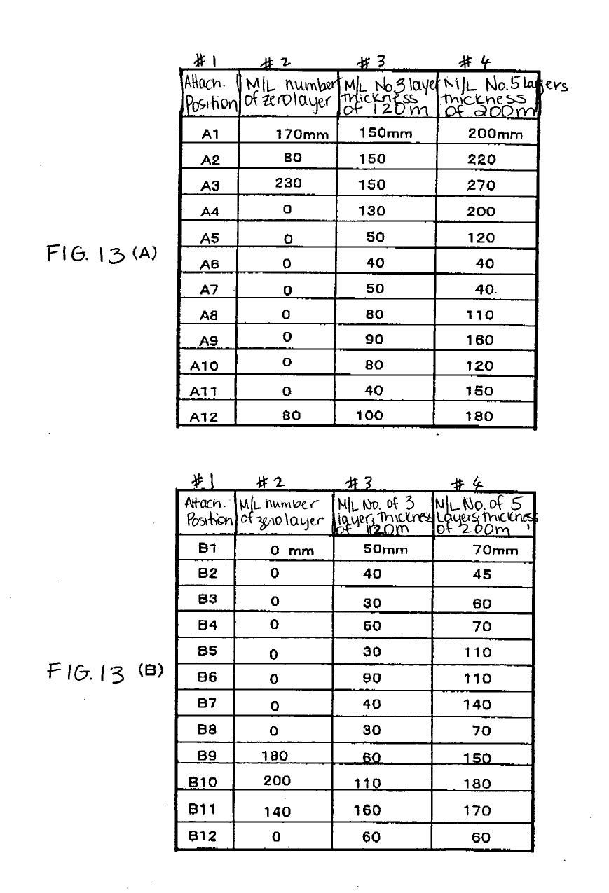

Next, the utilization method of the non-contact IC tag 50 fabricated will be described with reference to a perspective view shown in FIG. 11, a diagram illustrative of attachment positions shown in FIG. 12, and a diagram illustrative of the communication distance shown in FIG. 13.

FIG. 11 depicts an appearance image that a notebook personal computer 81 as an attachment target article is attached with the non-contact IC tag 50 and communicates with the non-contact IC tag 50 through an external communication antenna 85.

Since the notebook personal computer 81 has various electronic devices therein, the amount of the magnetic flux to pass is varied depending on the positions.

Then, as shown in FIG. 12, the change in the communication distance will be described at 12 positions on the front side A (A1 to A12), and 12 positions on the back side B (B1 to B12) when the notebook personal computer 81 is closed.

In a table shown in FIG. 13, A depicts the communication distance when the tag is attached on the front side, and B depicts the communication distance when attached to the back side. In this example, a non-contact IC tag 50 having the resonance frequency adjusted to 10.8 MHz is used.

It is revealed from this that the communication distance is varied depending on the attachment positions of the non-contact IC tag 50 and the tag can communicate without providing the high permeable layer 35 when the attachment positions are A1 to A3, A12, and B9 to B11.

Furthermore, when the attachment position is A4, it is revealed that the sufficient communication distance can be obtained even though the high permeable layer 35 is thin (even three layers).

Moreover, at the attachment positions A1, A3, B9, and B10, it is revealed that there are properties that the communication distance is prolonged when no high permeable layer is provided.

The difference in the communication distance depending on the attachment position is caused by the arrangement of the electronic components or the metal components inside the notebook personal computer 81 of an electronic device because the form of shielding the induction field is varied depending on the positions between the metal components and the non-contact IC tag 50.

Correspondingly, the layer thickness of the high permeable layer 35 is freely adjusted to select optimum properties matched with the purposes for use in good balance with respect to the cost.

More specifically, the non-contact IC tag 50 having no high permeable layer 35 or having the high permeable layers 35 laminated by the number of layers in accordance with the required communication distance is offered, and thus the non-contact IC tag 50 that secures communication features requested by a user can be offered.

In addition, in the embodiment above, the configuration may be formed in which ID data is written to the memory in the IC 56 at Step n11 and the same ID data as this is written to the magnetic layer 45 at Step n12.

In this case, ID data does not need to be written to the memory in the IC 56 beforehand to intend to reduce cost.

Furthermore, the configuration may be formed in which the order of thermal transfer of the high permeable layer 35 and the magnetic layer 45 is changed; to the non-contact IC tag main body 60, the magnetic layer 45 is thermally transferred and then the high permeable layer 35 is laminated on the surface of the magnetic layer 45. In this case, magnetic data recorded in the magnetic layer 45 can be read through the sheet 51 as the non-contact IC tag 50 is attached to the article 80.

Moreover, the configuration may be formed in which a member having high permeability and a member having high magnetic holding power are blended to combine the high permeable layer 35 with the magnetic layer 45 to form a single layer. In this case, fabrication process steps can be decreased to intend to reduce cost.

Besides, the high permeable layer 35 is provided nearly throughout the surface of the sheet 51, but the configuration may be formed in which it is formed in a predetermined shape connecting the inside to the outside of the antenna coil 53 seen in plan and is partially provided to the sheet 51. Also in this case, the magnetic flux can be passed.

Furthermore, in the embodiment above, the magnetic layer 45 and the high permeable layer 35 are formed as the surface areas thereof are the same and the positions are aligned so as not to misalign both layers, but they may be formed in such a way that one of them is formed greater, or they are formed so as to generate a shift in the thermal transfer areas between the magnetic layer 45 and the high permeable layer 35. Also in this case, the high permeable layer 35 can guide the magnetic flux passing through the inside of the antenna coil 53 to the outside of the antenna coil 53, and can record magnetic data in the magnetic layer 45.

Moreover, it may be formed that a hole is perforated at the position where the electronic component module 57 is not disposed such as the center part of the sheet 51, or the magnetic layer 45 is projected so as to be partially protruded from the side part of the non-contact IC tag 50. In this case, magnetic data can be easily read out of the magnetic layer 45 as the non-contact IC tag 50 is attached to the article 80.

Besides, the configuration may be formed in which a process to determine whether the number of layers is zero is added before Step n3 in FIG. 5 and the process skips to Step n11 when the number of layers is zero.

In this case, the non-contact IC tag 50 having no high permeable layer 35, the non-contact IC tag 50 having a single layer of the high permeable layer 35, and the non-contact IC tag 50 having multiple layers of the high permeable layer 35 can be freely fabricated by the same non-contact IC tag fabrication apparatus 1.

Thus, for orders in a small volume of lots, the non-contact IC tag 50 can be fabricated for sale promptly without changing the layout of the fabrication facilities.

Furthermore, the thickness of the high permeable layer 35 of the high permeable layer ribbon 30 set to each of the thermal transfer heads 161 is all set the same, but the configuration may be formed that ribbons having different thicknesses are set.

For example, when the thermal transfer heads are set so that the thermal transfer head 161 at the first stage has a thickness of 40 μm, the thermal transfer head 161 at the second stage has a thickness of 80 μm, and the thermal transfer head 161 at the third stage has a thickness of 160 μm, the high permeable layers 35 having seven thicknesses, 40 μm, 80 μm, 120 μm, 160 μm, 200 μm, 240 μm, and 280 μm, can be obtained by three thermal transfer heads 161. The thickness can be obtained that has the types greater than the number of the thermal transfer heads 161.

In this case, the thickness of the high permeable layer 35 of the high permeable layer ribbon 30 set to each of the thermal transfer heads 161 can be set in integral multiples, or the other settings.

Moreover, for the resin binder in forming the high permeable layer 35 on the high permeable layer ribbon 30, a binder may be used in which a thermosetting epoxy resin is solved in a solvent such as methyl ethyl ketone.

In this case, the high permeable layer ribbon 30 for thermal transfer may be produced in which magnetic powder (for example, iron-niobium alloy particles) is dispersed in a resin binder to form paste, the paste is applied onto the surface of the film 31, and then the solvent in the applied layer is volatilized at a temperature of about 150° C.

At this time, the volatilization amount of the solvent is suppressed to dry the high permeable layer 35 so that the solvent remains about 20 g per square meter, for example. Thus, the high permeable layer 35 can be formed on the non-contact IC tag main body 60 by the same thermal transfer method as that of the embodiment using the polyester resin binder described above.

Besides, the configuration may be formed in which a single thermal transfer head 161 is provided, not multiple heads.

In this case, a series of thermal transfer process steps may be set by a given number of times to perform in which the thermal transfer head 161 thermally transfers the high permeable layer 35 on the high permeable layer ribbon 30 to move the position of the high permeable layer ribbon 30 as the tag carrying module 15 temporarily stops winding forward the non-contact IC tag roll 70.

Therefore, a single thermal transfer head 161 can freely adjust the number of layers of the high permeable layer 35 of the non-contact IC tag 50.

Furthermore, as similar to the thermal transfer head 161 which thermally transfers the high permeable layer 35, the thermal transfer head 171 which thermally transfers the magnetic layer 45 may be provided in multiple stages to form multiple layers of the magnetic layer 45, or may perform thermal transfer by the multiple number of times to form multiple layers of the magnetic layer 45.

Moreover, the non-contact IC tag 50 may be configured to have no high permeable layer 35. In this case, the non-contact IC tag fabrication apparatus 1 can be configured to have no thermal transfer head 161 to intend to reduce cost.

Also in this case, the non-contact IC tag 50 can store IC data in the memory in the IC 56 as well as magnetic data in the magnetic layer 45. Therefore, it can be used effectively when the article 80 of an attachment target is not a metal product, and the non-contact IC tag 50 can be offered at low cost.

Besides, the non-contact IC tag fabrication apparatus 1 may have a write display unit which writes data visibly to the non-contact IC tag 50.

In this case, the configuration may be formed in which the write display unit performs laser processing to the high permeable layer 35 with a write head in accordance with the control signal of the control module 10 and data such as the number of layers of the high permeable layer 35 is written visibly.

For data written by the write head, proper data may be written in accordance with purposes for use and customer's requests, such as resonance frequencies, types of the non-contact IC tag, manufacturer data, sales data, or data for attachment target articles, not limited to the number of layers.

Furthermore, for the data, it may be used such a way that indications of win/lose are written, for example, for adding entertainment elements to the non-contact IC tag 50. In this case, the attachment side may be written to see win/lose when an article is peeled.

Therefore, for example, in the case where the non-contact IC tag 50 is attached to a final product such as clothes, ordinary consumers can be prevented from feeling troublesome about the non-contact IC tag 50, and can contrary be made pleased for expectation of win by the non-contact IC tag 50.

In addition, the write head may be configured of other pieces of apparatus that can write visibly, such as print by ink jet, print by thermal transfer, or etching by engraving, not limited to laser processing.

Moreover, the position to write the data may be set on the attachment side so as not to visibly recognize data after the non-contact IC tag is attached to an article, or set to the non-contact IC tag side so as to visibly recognize data after the tag is attached to an article.

With the configuration, convenience in use of the non-contact IC tag can be enhanced, such as identification of types of the non-contact IC tag, use as security data, and traceability to manufacturers.

The correspondence between the configurations of the invention and the embodiment above is as follows:

the thermal transfer module of the invention corresponds to the thermal transfer unit 16 of the embodiment,

the magnetic data holding unit corresponds to the high permeable layer 35 and the magnetic layer 45,

the antenna corresponds to the antenna coil 53,

the storage unit corresponds to the memory in the IC 56,

the magnetic data holding member corresponds to iron oxide (γFe₂O₃) or chromium dioxide (CrO₂) having a crystal grain size of 350 to 380 angstrom, and iron-niobium alloy particles,

the magnetic member corresponds to iron oxide (γFe₂O₃) or chromium dioxide (CrO₂) having a crystal grain size of 350 to 380 angstrom, and

the high permeability member corresponds to iron-niobium alloy particles.

However, the invention is not limited only to the configurations of the embodiment above, which can obtain various embodiments.

FIG. 1

1 NON-CONTACT IC TAG FABRICATION APPARATUS
1 NON-CONTACT IC TAG FABRICATION APPARATUS
35 HIGH PERMEABLE LAYER
45 MAGNETIC LAYER
50 NON-CONTACT IC TAG
60 NON-CONTACT IC TAG MAIN BODY
   FIG. 2
35 HIGH PERMEABLE LAYER
   FIG. 3
35 HIGH PERMEABLE LAYER
50 NON-CONTACT IC TAG
60 NON-CONTACT IC TAG MAIN BODY
   FIG. 4
#1 NON-CONTACT IC TAG FABRICATION APPARATUS
10 CONTROL UNIT
11 INPUT UNIT
15 TAG CARRYING UNIT
16 THERMAL TRANSFER UNIT
17 RIBBON CARRYING UNIT
21 IC DATA READ/WRITE UNIT
22 MAGNETIC DATA READ/WRITE UNIT
   FIG. 5
#1 START
n1 SET INPUT
n2 START CARRYING
n3 NUMBER OF LAYERS≦1
#3 (IN THE CASE OF A SINGLE LAYER)
n4 <PERFORM THERMAL TRANSFER>
   HIGH PERMEABLE LAYER (ONLY AT THE FIRST STAGE)
   MAGNETIC LAYER
n5 CARRY (ONLY AT THE FIRST STAGE)
   (MAGNETIC LAYER)
n6 NUMBER OF LAYERS≦2
#4 (IN THE CASE OF TWO LAYERS)
n7 <PERFORM THERMAL TRANSFER>
   HIGH PERMEABLE LAYER (FIRST TO SECOND STAGES)
   MAGNETIC LAYER
n8 CARRY (FIRST TO SECOND STAGES)
   (MAGNETIC LAYER)
#5 (IN THE CASE OF THREE LAYERS)
n9 <PERFORM THERMAL TRANSFER>
   HIGH PERMEABLE LAYER (FIRST TO THIRD STAGES)
   MAGNETIC LAYER
n10 CARRY (FIRST TO THIRD STAGES)
   (MAGNETIC LAYER)
n11 READ IC DATA
n12 WRITE MAGNETIC DATA
#2 END
   FIG. 6
50 NON-CONTACT IC TAG
53 ANTENNA COIL
   FIG. 7
35 HIGH PERMEABLE LAYER
45 MAGNETIC LAYER
50 NON-CONTACT IC TAG
60 NON-CONTACT IC TAG MAIN BODY
   FIG. 8
35 HIGH PERMEABLE LAYER
45 MAGNETIC LAYER
60 NON-CONTACT IC TAG MAIN BODY
80 ARTICLE
   FIG. 9
35 HIGH PERMEABLE LAYER
45 MAGNETIC LAYER
80 ARTICLE
   FIG. 10
#1 NUMBER OF LAYERS
#2 THICKNESS OF THE LAYER
#3 COMMUNICATION DISTANCE WHEN ATTACHED TO A METAL PLATE
#4 OPTIMAL RESONANCE FREQUENCY
   FIG. 11
50 NON-CONTACT IC TAG
   FIG. 12
#1 (FRONT SIDE)
#2 (BACK SIDE)
   FIG. 13
   A
#1 ATTACHMENT POSITION
#2 MULTI-LAYER NUMBER OF ZERO LAYER
#3 MULTI-LAYER NUMBER OF THREE LAYERS
   LAYER THICKNESS OF 120 μM
#4 MULTI-LAYER NUMBER OF FIVE LAYERS
   LAYER THICKNESS OF 200 μM
      B
#1 ATTACHMENT POSITION
#2 MULTI-LAYER NUMBER OF ZERO LAYER
#3 MULTI-LAYER NUMBER OF THREE LAYERS
   LAYER THICKNESS OF 120 μM
#4 MULTI-LAYER NUMBER OF FIVE LAYERS
   LAYER THICKNESS OF 200 μM

What is claimed is:

1. A method of fabricating a non-contact IC tag, the non-contact IC tag having:
a storage unit which stores information; and
an antenna which communicates in a non-contact manner,
wherein a magnetic data holding member which magnetically holds data is thermally transferred to a non-contact IC tag main body.

2. The method of fabricating a non-contact IC tag according to claim 1, wherein:
a high permeability member of high permeability and a magnetically recordable magnetic member is used as the magnetic data holding members, and
the high permeability member and the magnetic member are separately thermally transferred.

3. A apparatus of fabricating a non-contact IC tag, the non-contact IC tag having:
a storage unit which stores information; and
an antenna which communicates in a non-contact manner,
the apparatus comprising:
a thermal transfer module which thermally transfers a magnetic data holding member magnetically holding data to a non-contact IC tag main body.

4. The apparatus of fabricating a non-contact IC tag according to claim 3, wherein:
a high permeability member of high permeability and a magnetically recordable magnetic member is used as the magnetic data holding members, and
the thermal transfer module is provided in multiple modules as corresponds to the high permeability member and the magnetic member.

5. A non-contact IC tag comprising:
a storage unit which stores information; and
an antenna which communicates in a non-contact manner, and
further comprising:
a magnetic data holding unit which magnetically holds data.

6. The non-contact IC tag according to claim 5, wherein:
the magnetic data holding unit is configured of:
a high permeable layer which is formed flat of a member of high permeability; and
a magnetically recordable magnetic layer.
